(19) United States
(12) Patent Application Publication
(10) Pub. No.: US 2013/0181894 A1
(43) Pub. Date: Jul. 18, 2013

(54) DISPLAY DEVICE AND METHOD FOR LARGE SCREEN

(71) Applicant: ZHEN-WEI XU, Shenzhen City (CN)

(72) Inventor: ZHEN-WEI XU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/479,303

(22) Filed: May 24, 2012

(30) Foreign Application Priority Data
Jan. 13, 2012 (CN) 201210010866.1

(51) Int. Cl. G06F 3/01

(52) U.S. Cl. 345/156

(57) ABSTRACT

A display device includes a display screen, a distance sensing unit, set on an appropriate position of the display screen to sense a relative distance from a user to the display device; a processing unit comprising a projection position determining module, a stretching area determining module, and a display control module. The projection position determining module calculates a projected position of the user on the display screen according to a position of the distance sensing unit on the display screen, the projected position is the position on the display screen where the user is projected on. The stretching area determining module determines an area needed to be stretched on the display screen according to the projected position on the display screen and a predetermined distance. The display control module stretches content displayed on the area needed to be stretched according to a predetermined percentage. The display method is also provided.

### BACKGROUND

1. Technical Field

The present disclosure relates to display devices and display methods thereof, and more particularly, to a display device and display method for large screen.

2. Description of Related Art

Display devices have display screen sizes of 40″, 46″, 52″ or 60″. The size of content displayed on edges of the display screen appears narrowed when compared with displayed on the center of the display screen, which causes visual discomfort.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of a first embodiment of a display device, in accordance with the present disclosure.

FIG. 2 is a schematic diagram of sensing distance from a user by the display device of FIG. 1, in accordance with the present disclosure.

FIG. 3 is a flowchart of a first embodiment of display method implemented by the display device of FIG. 1, in accordance with the present disclosure.

FIG. 4 is a display schematic diagram of the display device of FIG. 1, in accordance with the present disclosure.

FIG. 5 is a block diagram of a second embodiment of a display device, in accordance with the present disclosure.

FIG. 6 is a schematic diagram of capturing images of the display device of FIG. 5, in accordance with the present disclosure.

FIG. 7 is a flowchart of a second embodiment of display method implemented by the display device of FIG. 5, in accordance with the present disclosure.

### DETAILED DESCRIPTION

Embodiments of the present disclosure will be described with reference to the accompanying drawings.

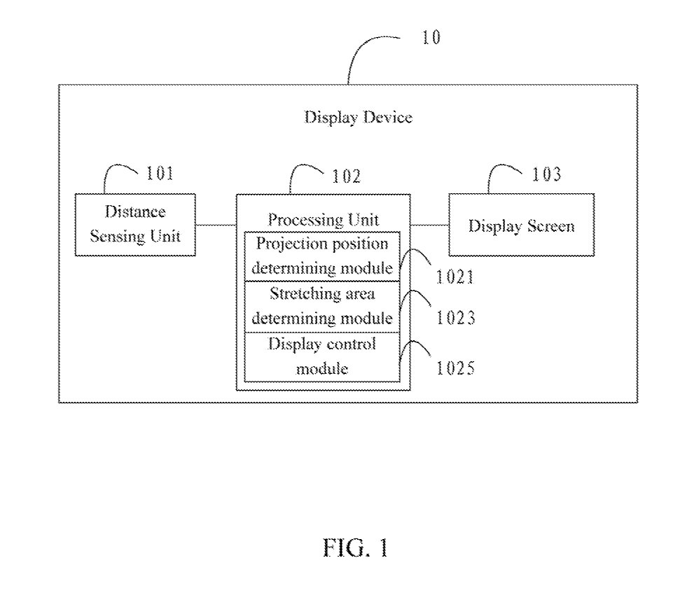

FIG. 1 is a block diagram of a first embodiment of a display device, in accordance with the present disclosure. The display device 10 includes a distance sensing unit 101, a processing unit 102, and a display screen 103.

The display screen 103 is used to display data, including image, video file, audio file, or text. The display screen 103 may be a display screen with large size. The distance sensing unit 101 is set on an appropriate position of the display screen 103 for sensing a relative distance from the user to the display device 10.

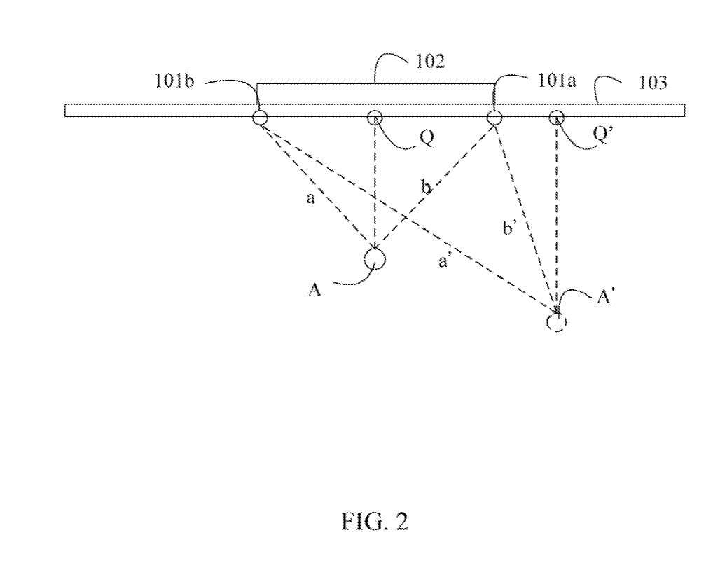

See FIG. 2, the distance sensing unit 101 includes two distance sensors 101a and 101b, respectively set on different positions of the display screen 103. At position A, the distance sensor 101a senses a distance from the user a, the distance sensor 101b senses a distance from the user b. According to a distance between the two sensors 101a and 101b positioned on the display screen 103, the distance a sensed by the distance sensor 101a, the distance b sensed by the distance sensor 101b, a vertical distance of the position A relative to the display screen 103 and a projected position Q of the position A on the display screen 103 can be calculated. The projected position is the position on the display screen 103 where the user is projected on.

At position A′, the distance sensor 101a senses a distance from the user a′, the distance sensor 101b senses a distance from the user b′. According to the distance between the two distance sensors 101a and 101b positioned on the display screen 103, the distance a′ sensed by the distance sensor 101a, the distance b′ sensed by the distance sensor 101b, a vertical distance of the position A′ relative to the display screen 103 and a projected position Q′ of the position A′ on the display screen 103 can be calculated.

The processing unit 102 includes a projection position determining module 1021, a stretching area determining module 1023, and a display control module 1025.

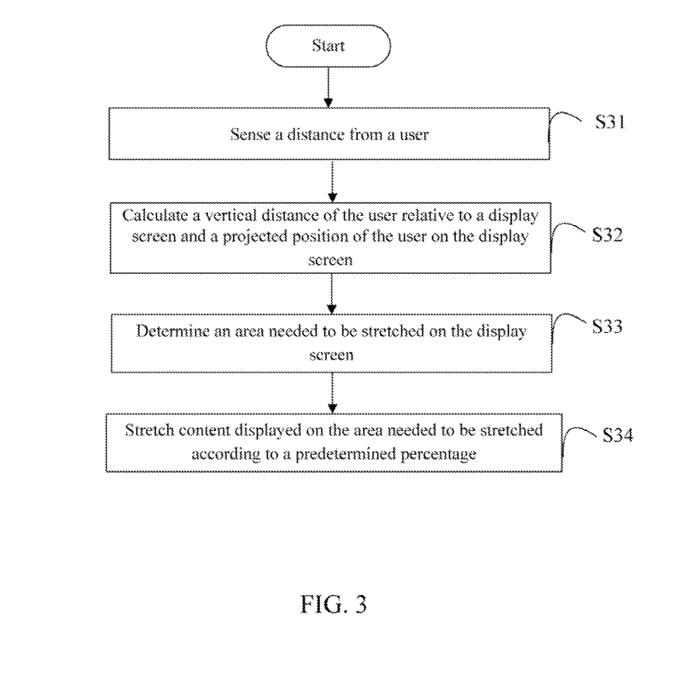

FIG. 3 is a flowchart of a first embodiment of display method implemented by the display device of FIG. 1, in accordance with the present disclosure.

In step S31, the distance sensor 101a senses the distance from the user a, and the distance sensor 101b senses the distance from the user b.

In step S32, the projection position determining module 1021 calculates the vertical distance of the position A relative to the display screen 103 and the projected position Q of the position A on the display screen 103 according to the distance between the two distance sensors 101a and 101b positioned on the display screen 103, the distance a sensed by the distance sensor 101a, and the distance b sensed by the distance sensor 101b.

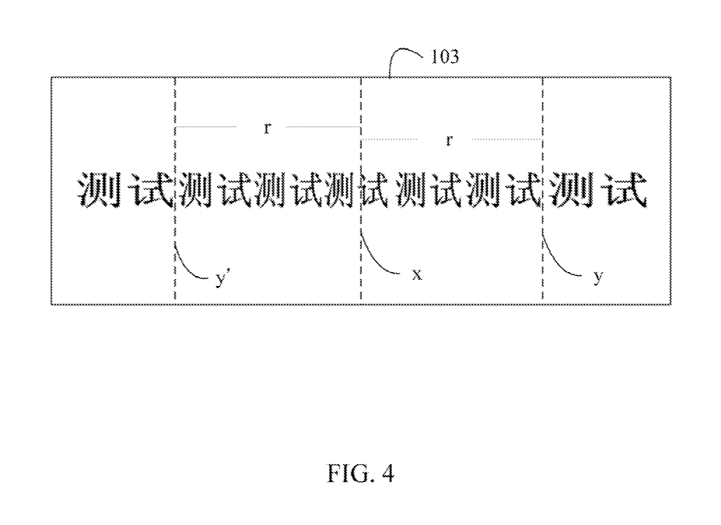

In step S33, the stretching area determining module 1023 determines an area needed to be stretched on the display screen 103 according to the projected position Q on the display screen 103 and a predetermined distance r. See FIG. 4, assuming that the user is in the position A, the projected position Q of the position A on the display screen 103 is on a dotted line x, the stretching area determining module 1023 determines the boundary y and y′ which is away from the dotted line x for the distance r, thereby determining the area beyond the boundary y and y′ is the area needed to be stretched. The value of the distance r is pre-set by system.

In step S34, see FIG. 4, the display control module 1025 stretches content displayed on the area needed to be stretched according to a predetermined percentage. The predetermined percentage is pre-set by system.

In other embodiments, when the user moves, the distance sensed by the distance sensing unit 101 may change accordingly, therefore, the distance sensing unit 101 can be set to sense the distance from the user relative to the display screen 103 periodically. If the distance changes when compared with previously sensed distance, the procedure repeats steps S32 to S34, and if the distance does not change when compared with previously sensed distance, the procedure need not to repeat the steps of S32 to S34.

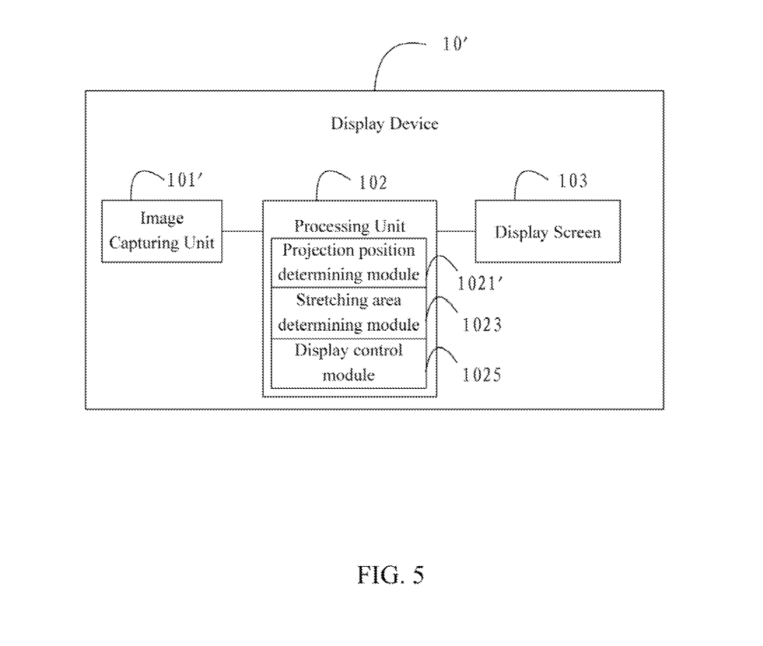

FIG. 5 is a block diagram of a second embodiment of a display device, in accordance with the present disclosure. Compared with the display device of FIG. 1, the distance sensing unit 101 of the display device 10 is replaced with an image capturing unit 101′. The image capturing unit 101′ is fixed on the display screen 103.

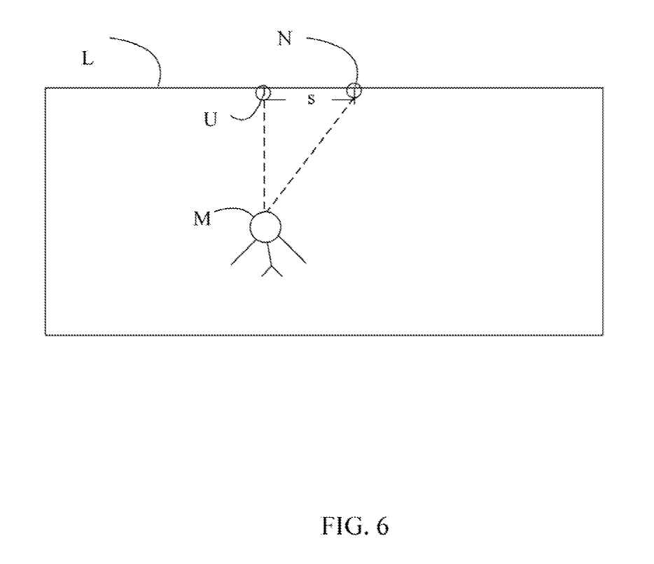

FIG. 6 is a schematic diagram of capturing images of the display device of FIG. 5, in accordance with the present disclosure. The image capturing unit 101′ captures an image L, a position of the user in the image is M, a position of the image capture unit 101′ in the image is N, the horizontal distance between the M and N in the image is s. As scaling parameters can be calculated when the image L is captured, the actual horizontal distance between the user and the image capture unit 101′ can be calculated according to the horizontal distance s between M and N in the image, thereby the projected position U of the user on the display screen 103 can be determined. The method of identifying the position of the user in the image is M and the position of the image capture unit 101′ in the image can be referenced by existing technologies, such as face recognition technology.

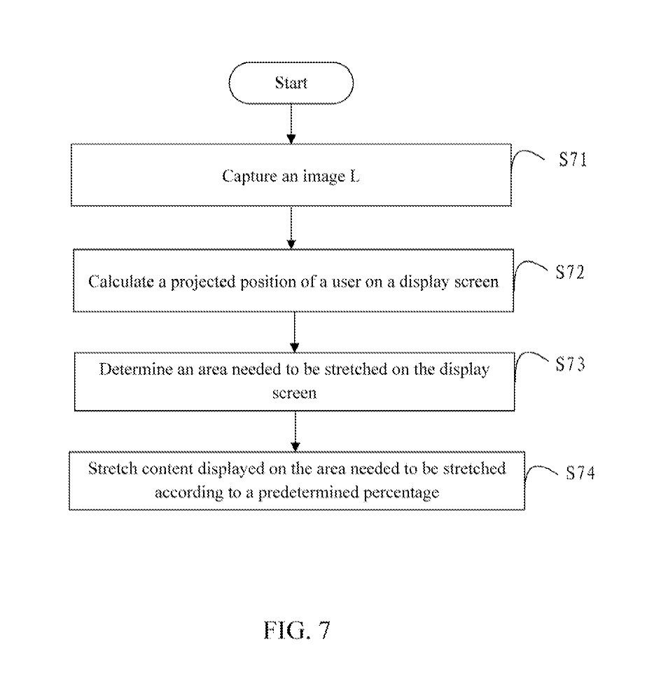

FIG. 7 is a flowchart of a second embodiment of display method implemented by the display device of FIG. 5. Compared with the method of FIG. 3, step S71 and S72 are changed. In step S71, the image capturing unit 101′ captures the image L. In step S72, the projection position determining module 1021 calculates the projected position U of the user on the display screen 103 according to the position of the user in the image M, the position of the image capture unit 101′ in the image N, the horizontal distance s between the M and N in the image, and the scaling parameters when the image L is captured.

In other embodiments, when the user moves, the projected position U of the user on the display screen 103 may change accordingly, therefore, the image capturing unit 101′ can be set to capture images periodically, the projection position determining module 1021 calculates the projected position U of the user on the display screen 103 periodically. If the projected position of the user on the display screen 103 changes when compared with previous projected position, the procedure repeats steps S73 to S74, and if the projected position of the user on the display screen 103 does not change when compared with previous projected position, the procedure need not to repeat the steps of S S73 to S74.

Though the method above, by adding the distance sensing unit 101 or the image capturing unit 101′, the content displayed on the area outside a fixed distance on the display screen 103 is stretched by a predetermined percentage, which is easier for the user and reduces visual discomfort.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A display device comprising:
a display screen;
a distance sensing unit, set on the display screen to sense a relative distance from a user to the display device;
a processing unit comprising a projection position determining module, a stretching area determining module, and a display control module,
wherein the projection position determining module calculates a projected position according to a position of the distance sensing unit on the display screen, the projected position is the position on the display screen where the user is projected on, the stretching area determining module determines an area needed to be stretched on the display screen according to the projected position on the display screen and a predetermined distance, and the display control module stretches content displayed on the area needed to be stretched according to a predetermined percentage.

2. The display device of claim 1, wherein the predetermined percentage is pre-set by system.

3. The display device of claim 1, wherein the distance sensing unit comprises two distance sensors, respectively set on two different positions of the display screen, the projection position determining module calculates the projected position of the user on the display screen according to a distance between the two distance sensors on the display screen, two distances sensed by the two distance sensors.

4. The display device of claim 1, wherein the distance sensing unit senses the distance from the user relative to the display screen periodically, if the distance changes when compared with previously sensed distance, the projection position determining module repeats to calculate a projected position of the user on the display screen according to position of the distance sensing unit on the display screen, the stretching area determining module determines an area needed to be stretched on the display screen according to the projected position on the display screen and a predetermined distance, and the display control module stretch content displayed on the area needed to be stretched according to a predetermined percentage.

5. A display method implemented by a display device comprising:
sensing a relative distance from a user to the display device by a distance sensing unit set in a display screen of the display device;
calculating a projected position of the user on the display screen according to position of the distance sensing unit on the display screen;
determining an area needed to be stretched on the display screen according to the projected position on the display screen and a predetermined distance; and
stretching content displayed on the area needed to be stretched according to a predetermined percentage.

6. The display method of claim 4, wherein the predetermined percentage is pre-set by system.

7. The display method of claim 5, wherein the distance sensing unit is two distance sensors, respectively set on different positions of the display screen, the method further comprises calculating the projected position of the user on the display screen according to a distance between the two distance sensors on the display screen, two distances sensed by the two distance sensors.

8. The display method of claim 5, wherein the method further comprises:
sensing the distance from the user relative to the display screen periodically by the distance sensing unit;
if the distance changes when compared with previously sensed distance, repeating the steps of calculating a projected position of the user on the display screen according to position of the distance sensing unit on the display screen;
determining an area needed to be stretched on the display screen according to the projected position on the display screen and a predetermined distance; and
stretching content displayed on the area needed to be stretched according to a predetermined percentage.

9. A display device comprising:
a display screen;
an image capturing unit, fixed on the display screen to capture an image;
a processing unit comprising a projection position determining module, a stretching area determining module, and a display control module,
wherein the projection position determining module calculates a projected position of a user on the display screen according to a position of the user in the image, a position of the image capture unit in the image, a horizontal distance between the user and image capture unit in the image, and scaling parameters when capturing the image, the projected position is the position on the display screen where the user is projected on; the stretching area determining module determines an area needed to be stretched on the display screen according to the projected position on the display screen and a predetermined distance, and the display control module stretches content displayed on the area needed to be stretched according to a predetermined percentage.

10. The display device of claim 9, wherein the predetermined percentage is pre-set by system.

11. The display device of claim 9, wherein the image capturing unit is a camera.

12. The display device of claim 9, wherein the image capturing unit captures images periodically, the projection position determining module calculates the projected position of the user on the display screen periodically, if the projected position changes when compared with previously projected position, the stretching area determining module repeats to determine an area needed to be stretched on the display screen according to the projected position on the display screen and a predetermined distance, and the display control module stretches content displayed on the area needed to be stretched according to a predetermined percentage.

13. A display method implemented by a display device comprising:
capturing an image by an image capturing unit fixed on a display screen;
calculating a projected position of a user on the display screen according to a position of the user in the image, a position of the image capture unit in the image, a horizontal distance between the user and image capture unit in the image, and scaling parameters when capturing the image, the projected position is the position on the display screen where the user is projected on;
determining an area needed to be stretched on the display screen according to the projected position on the display screen and a predetermined distance; and
stretching content displayed on the area needed to be stretched according to a predetermined percentage.

14. The display method of claim 13, wherein the predetermined percentage is pre-set by system.

15. The display method of claim 13, wherein the method further comprises:
capturing images periodically;
calculating the projected position of the user on the display screen periodically;
if the projected position changes when compared with previously projected position, repeating the steps of determining an area needed to be stretched on the display screen according to the projected position on the display screen and a predetermined distance; and stretching content displayed on the area needed to be stretched according to a predetermined percentage.
